(19) United States
(12) Patent Application Publication
(10) Pub. No.: US 2022/0134770 A1
(43) Pub. Date: May 5, 2022

(54) THERMAL ENERGY DETERMINATION

(71) Applicant: Hewlett-Packard Development Company, L.P., Spring, TX (US)

(72) Inventors: Miguel Angel Lopez Alvarez, Vancouver, WA (US); Jay S. Gondek, Vancouver, WA (US); John J. Cantrell, Vancouver, WA (US); Yifeng Wu, Vancouver, WA (US)

(73) Assignee: Hewlett-Packard Development Company, L.P., Spring, TX (US)

(21) Appl. No.: 17/431,301

(22) PCT Filed: Jun. 13, 2019
(86) PCT No.: PCT/US2019/036908

§ 371 Date: Aug. 16, 2021

(51) Int. Cl. B41J 2/21

(52) U.S. Cl. CPC B41J 2/2103

(57) ABSTRACT

An example system for thermal energy determination can include a first controller comprising a processor and a non-transitory machine-readable medium (MRM) communicatively coupled to the processor. The non-transitory MRM can include instructions executable by the processor to cause the processor to receive relative humidity information of an environment of a thermal printing device, determine a colormap to a print media of the thermal printing device based on the relative humidity, and determine a particular thermal energy to apply to the print media based on the determined colormap.

### BACKGROUND

Imaging devices, such as printing devices and scanners, may be used for transferring print data onto a print media, such as paper. The print data may include, for example, a picture, text, or a combination thereof and may be received from a computing device. The imaging device may generate an image by processing pixels and/or colorants representing a determined tone to create an image and/or text.

### BRIEF DESCRIPTION OF THE DRAWINGS

FIG. 1 is an example system for thermal energy determination consistent with the disclosure.

FIG. 2 is a block diagram of an example computing device for thermal energy determination consistent with the disclosure.

FIG. 3 is an example method for thermal energy determination consistent with the disclosure.

### DETAILED DESCRIPTION

A printing device can form texts and images directly on a print media. In some examples, a printing device can form texts and graphics on an electro-statically charged drum just before transferring to the print media (e.g., laser printers). In some examples, colorants can be selectively activated by applying a high temperature to the colorants or associated print media. Reproduction of colorants using these methods can be affected by factors such as the volume of ink delivered, the type of printing medium, the spatial and temporal rules used to place the colorants on the print media, and environmental conditions, among others.

As used herein, the term “environmental conditions” refers to a condition present in the environment that can change a print job environment. For example, an environmental conditional can include air temperature, humidity, moisture in the environment, etc. Environmental conditions can affect an output of colorants of a printing device, and in some examples, environmental conditions can include information about the environment. For instance, information about the environment can include an internal temperature read of the environment, an external temperature read of the environment, weight change information of a print media, and/or colorants variation information.

In some approaches, a sensor in a printing device can receive information about a change in an environmental condition just before printing. That information can be used to modify operation of the printing device to compensate for effects of the environmental condition on colorants in printing results. In such an approach, compensating for effects of the environmental condition on colorants includes evaluating a mathematical expression that explicitly includes representations of colorant signals in the printing device and of at least one sensed environmental condition. However, such an approach is limited to incremental printing devices. As described herein, the term “incremental printing device” refers to printers and computers that perform computer-controlled construction of images by small increments (e.g., inkjet, dot-matrix, wax-transfer system, laser printers, etc).

In some approaches, a printing device to which a print job is sent can be remotely proofed by a remote proofing system to operate within predetermined calibration criteria for printing a print job. The printing device can operate a model to implement checks on various parameters such as ink level, environmental conditions (temperature, humidity, etc.), and print media type to determine if a recalibration process should be performed prior to printing a print job. However, in such an approach, recalibration parameters are setup at particular temperature and humidity intervals and/or when the a print job is being queued up.

In some approaches, a thermal printing device and thermal print media used in the thermal printing device can be calibrated to try to achieve consistent and accurate colorant output. As described herein, the term “thermal printing device” refers to a digital printing device which produces a printed image by selectively heating coated print media (e.g., thermal paper) when the print media passes over the thermal printhead. As described herein, the term “thermal printhead” refers to a heating device that generates thermal energy and facilitates printing on print media. As described herein, the term “thermal energy” refers to heat that facilitates printing on print media to get a desired colorant output for a print job. However, in such approaches, the calibration parameter for the thermal printing device is limited to temperature variation of the thermal printing device and the thermal print media.

The amount of moisture in the print media can impact the quality and accuracy of colorants that are printed on that print media. For instance, a print media with a plurality of layers can incorporate and/or release moisture from its inner layers depending on the humidity of the environment. In such examples, the time used for the print media to equilibrate to environmental humidity can vary from a few hours (e.g., when individually separated calibration sheets are placed in a testing environment) to several weeks (e.g., when the calibration sheets are wrapped together inside a foil envelop) which can result in inaccurate reproduction of colorants for that period of time.

Similarly, the amount of moisture in the print media can impact the quality and accuracy of colorants that will be printed on that print media. For example, if a relative humidity (RH) of an environment increases, the amount of moisture trapped in the print media layers may be higher than a print media in a controlled environment. As described herein, the term “controlled environment” refers to an environment with set parameters (e.g., 50% RH and 20-degrees Celsius (C) temperature) in which colorants are represented accurately. Thus, print media with more moisture may use more thermal energy from the printhead to activate the colorants. Similarly, when RH of an environment decreases, thermal conductivity of the print media can decrease. Thus, more thermal energy may be used from the printhead to activate the colorants in a relatively low humidity environment, which can result in loss of time, power, and energy.

Accordingly, the disclosure is directed towards thermal energy determination of a thermal printing device. Some examples of the present disclosure include a system that can receive real-time information about changes in RH of an environment of a thermal printing device and can determine a thermal energy to be applied to the print media to produce accurate and consistent colorants output. As described herein, the term “relative humidity” refers to the amount of water moisture in air expressed as a percentage of the amount used for saturation at the same temperature. As described herein, the term “real-time” refers to an actual time when a printing job is taking place.

In some examples, a thermal printing device can include an amorphochromic ink thermal printing device. As described herein, the term “amorphochromic ink thermal printing device” refers to a type of thermal printing device that includes amorphochromic ink coated in the thermal print media. As described herein, the term “amorphochromic inks” refer to colorless crystals which can convert to colored form by melting and retaining colorants after resolidification. In some examples, a particular thermal energy is applied based on the RH of the environment to retain colorants from the amorphochromic inks.

In some examples, information associated with an environment of a thermal printing device (e.g., environmental conditions) can be received from a sensor coupled to the thermal printing device. In some examples, information associated with the environment can be received from an external device (mobile device, weather application etc.). As described herein, the term “external device” refers to a device external to the printing device that receives information associated with the environment. For example, an external device may include a smart device, mobile device, weather application, etc. Based on the received information (e.g., RH information), the system can determine moisture content of a print media and determine a colormap to the print media. As described herein, the term “colormap” refers to numerical transform that is used to convert and/or modify colorant in an imaging system (e.g., International Color Consortium (ICC) profile).

As described herein, the term “moisture content” refers to the quantity of water in the print media. The system can determine a particular thermal energy to apply to the print media based on the determined colormap to optimize the colors printed on the print media. As described herein, the term “optimize the colorants” refers to producing a colorant on the print media that is an intended representation of the colorants in an environment.

A system that can receive information about changes in environmental conditions in real-time and/or immediately before printing a print job can determine a specific colormap from a plurality of colormaps and determine specific thermal energy for the determined colormap to provide consistent colorant output of that printing device over time, as well as consistent printer-to-printer and/or page-to-page colorants output. As described herein, the term “immediately” refers to an instant before a print job is being printed. For example, environmental conditions of a thermal printing device fifteen seconds before the print job is being printed. In some examples, RH data can be an average over time and/or can be a daily value. In some examples, RH data received over time may be used to estimate or model the moisture content of the print media, and the distribution of moisture through print media layers.

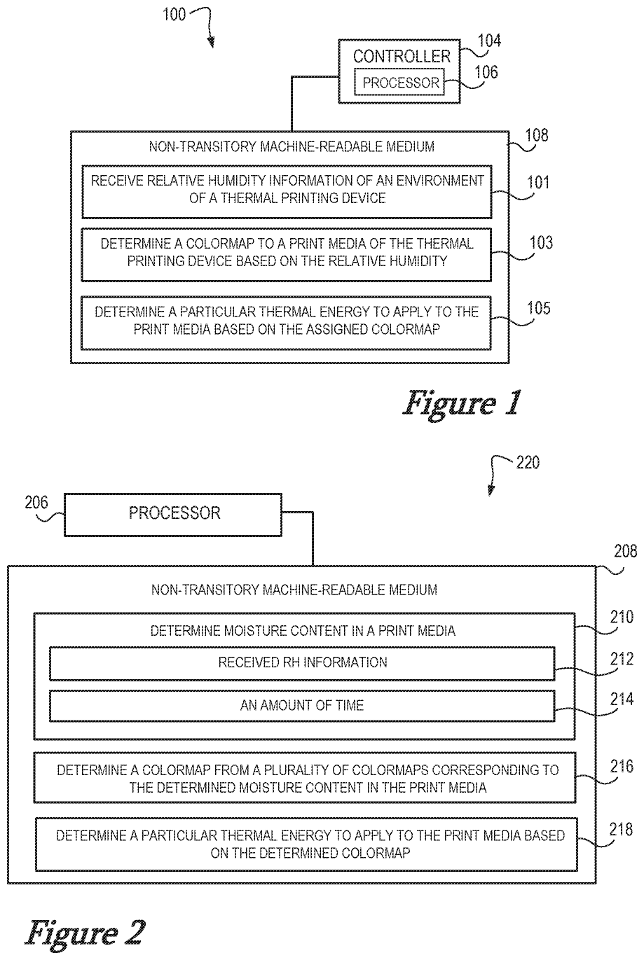

FIG. 1 is an example system 100 for thermal energy determination consistent with the disclosure. System 100 can be a computing device or part of a computing device. System 100 can include a controller 104 comprising a processor 106 communicatively coupled to a non-transitory machine-readable medium (MRM) 108 on which may be stored instructions, such as instructions 101, 103, and 105. As used herein, “communicatively coupled” can include coupled via various wired and/or wireless connections between devices such that data can be transferred in various directions between the devices. Although the following descriptions refer to a processor and a memory resource, the descriptions may also apply to a system with multiple processors and multiple memory resources. In such examples, the instructions may be distributed (e.g., stored) across multiple non-transitory MRMs and the instructions may be distributed (e.g., executed by) across multiple processors.

The non-transitory MRM 108 may be electronic, magnetic, optical, or other physical storage device that stores executable instructions. Thus, the non-transitory MRM 108 may be, for example, Random Access Memory (RAM), an Electrically-Erasable Programmable ROM (EEPROM), a storage drive, an optical disc, a CDB, and the like. The non-transitory MRM 108 may be disposed within a device, such as a computing device. In this example, the executable instructions 101, 103, and 105 can be “installed” on the device. Additionally and/or alternatively, the non-transitory MRM 108 can be a portable, external or remote storage medium, for example, that allows the system 100 to download the instructions 101, 103, and 105 from the portable/external/remote storage medium. In this situation, the executable instructions may be part of an “installation package”. As described herein, the non-transitory MRM 108 can be encoded with executable instructions for performing various functions described herein.

The controller 104 can be a combination of hardware and/or instructions for thermal energy determination. The hardware, for example, can include the processor 106 and/or the non-transitory MRM 108 communicatively coupled to the processor 106. In some examples, the controller 104 can be an ASIC, FPGA, MPCA, or other combination of circuitry and/or logic configured to orchestrate execution of instructions 101, 103 and 105.

The processor 106 may include processing circuitry such as a hardware processing unit such as a microprocessor, microcontroller, application specific instruction set processor, coprocessor, network processor, or similar hardware circuitry that may cause machine-readable instructions to be executed. In some examples, the processor 106 may be a plurality of hardware processing units that may cause machine-readable instructions to be executed. The processor 106 may include central processing units (CPUs) among other types of processing units.

Instructions 101, when executed by a processor such as the processor 106, can include instructions to receive RH information of an environment of a thermal printing device. In some examples, information of an environment can include an internal temperature read of the environment and an external temperature read of the environment. For example, a thermal printing device can be located inside a building and/or a room and information can be received about the temperature of the building and/or room housing the thermal printing device. In some examples, the thermal printing device can be located outside a building and/or room. In such an example, information can be received about the external temperature where the thermal printing device is located. In some examples, the information about the temperature can be received by a sensor (e.g., thermostat) and/or an external device. Additionally, information of an environment can include weight change information of a print media as further described herein. In some examples, information of an environment can include information associated with colorant variation of the print media. For example, information can be received that a colorants, for instance cyan, varies from an actual colorants in a controlled environment when printed on a print media. In some examples, based on the information of the environment mentioned herein, RH of the environment can be received.

Instructions 103, when executed by a processor such as the processor 106, can include instructions to determine a colormap to a print media of the thermal printing device based on the RH. A colormap can be determined from a plurality of colormaps (e.g., stored in memory). In some examples, the plurality of colormaps can be determined for different temperatures of a thermal printhead of a thermal printing device. For example, a colormap can be calculated from 20-degrees C. to 60-degrees C. at every 10-degrees C. In some examples, the printhead temperature of the printhead is read by a sensor, as further described herein. Based on the temperature, a colormap is calculated by interpolation from neighbor colormaps. For example, if the printhead temperature is 35-degrees C., then an average is taken from colormaps at 30-degrees C. and 40-degrees C. and used to determine the colormap at 35-degrees C.

In some examples, the system 100 can include a plurality of colormaps. In some examples, the plurality of colormaps can be humidity-adjusted colormaps. In some examples, the plurality of colormaps are determined for different RHs of the environment of a thermal printing device. For example, in a controlled environment a colormap can be calculated from 10% RH to 90% RH and the appropriate colormap can be used as the RH of the environment varies. In some examples, the RH of the environment of the thermal printing device is read by a sensor and/or an external device. Based on the RH of the environment, a colormap is calculated by interpolation from the neighbor RHs. For example, if an RH of the environment is 35%, then an average is taken from colormaps at 30% RH and 40% RH and used to determine the colormap at 35% RH. In some examples, additional information of the environment can be received via the sensor. For example, the sensor can provide additional information about the internal temperature of the environment, external temperature of the environment, weight change information of the print media, and/or colorant variation.

In some examples, instructions 103, when executed by the processor 106, can include instructions to determine a colormap based on a moisture content of the print media. Moisture content can be based on the RH of the environment and an amount of time the print media is in the environment. For example, if the RH of the environment is 60%, a moisture content of a print media can be 4%, and if the RH of the environment is 90%, the moisture content of the print media can be 6%. In some examples, moisture content can be based on an amount of time the print media is in the environment. For example, the moisture content of a print media exposed to the environment for a period of time can have increased moisture content as the duration of the print media being increased in the environment increases.

In some examples, RH information of the environment of the thermal printing device can be received from a smart device (e.g., smart phones, tablets, smartwatches, smart bands, smart key chains, smart speakers, etc.), embedded global positioning system (GPS), weather applications, etc. For example, a weather application can determine the RH information based on the temperature and humidity of a room where a thermal printing device is located. In some examples, the humidity and temperature can be determined by a sensor in the GPS that detects the change in temperature and humidity. In some examples, a GPS embedded in a printing device can determine RH based on the location of the thermal printing device. For example, if a thermal printing device is moved from a first location to a second location, the built in GPS of the printing device may determine the RH of the first location to be different from the second location.

In some examples, RH of the environment can be received based on an amount of time a print media is in the environment. For example, the thermal printing device can estimate the time passed since the next print media (e.g., thermal paper) to be printed has been stored on the top of the paper tray, by recording the last time a calibration sheet was read and the time from last page print.

In some examples, humidity sensors embedded in the thermal printing device (e.g., embedded in a print media tray) can receive an estimate of the humidity and/or moisture content in the print media. In some examples, weight sensors embedded in the thermal printing device can receive an estimate of the humidity and/or moisture content in the print media. A weight sensor can determine the change in RH by determining the weight change of a print media at various time points.

In some examples, the determinant of the colormap can change in response to a change in RH. For example, instructions 103 can include instructions to determine a first colormap based on the received information that the RH of the environment of the thermal printing device is 20%. If the RH of the environment of the thermal printing device changes from 20% to 40%, a second colormap can be determined in response to the change in RH. In some examples, the change and/or adjustment of the colormap responsive to the change in RH can occur during a print job. For example, if the RH of the environment changes in the middle of a print job, a third colormap can be determined during the print job. In some examples, the change and/or adjustment of the colormap, responsive to the change in RH, can occur prior to starting a print job. In the example above, changing the first colormap at 20% RH to a second colormap at 40% can occur immediately prior to starting a print job. In some examples, changing colormaps can change a thermal energy to be applied to the print media for accurate representation of colorants, as further described herein.

Instructions 105, when executed by a processor such as the processor 106, can include instructions to determine a particular thermal energy to apply to the print media based on the determined colormap. For example, a first thermal energy to apply to the print media can be determined based on the determined first colormap. In some examples, a second thermal energy to apply to the print media can be based on the determined second colormap.

In some examples, non-transitory MRM 108 can include instructions executable by processor 106 to apply the particular thermal energy via a heating device within the thermal printing device. In some examples, the heating device can generate heat to activate a thermo-sensitive coloring layer of a thermal print media, which may change colorants in areas where heat is received. In some instances, the heating device can be a printhead.

In some examples, RH information can be received by an external device, described herein. In some examples, the external device can provide the thermal energy to be applied according to the RH information. Based on that information, a particular thermal energy can to be applied on the print media for accurate representation of colorants. In some examples, the determined thermal energy can be redetermined in response to a changing colormap.

In some examples, thermal energy can be heat energy that optimizes the colorants printed on the thermal print media. In some examples, thermal energy can be internal energy of the system 100 that, when activated, optimizes the colorants printed on the thermal print media. In some examples, the applied particular thermal energy can be an applied heat that variably develops amorphochromic inks coated into the print media in accordance with the colormap. The particular thermal energy, determined based on determined colormap, can correct colorants shifts caused by moisture content of the thermal print media.

FIG. 2 is a block diagram of an example computing device 220 for thermal energy determination consistent with the disclosure. Computing device 220 can include a processor 206 communicatively coupled to a non-transitory MRM 208 on which may be stored instructions, such as instructions 210, 216, and 218.

Instructions 210, when executed by a processor such as the processor 206, can include instructions to determine moisture content in a print media. Determining the moisture content can be based on a received RH information 212 of an environment of a thermal printing device and an amount of time the print media is in the environment 214.

For example, instructions 210, when executed by processor 206 can determine moisture content based on a received RH information of an environment. In some examples, RH information can be received from a sensor (e.g., a humidity sensor and/or a weight sensor). In some examples, RH information of an environment can be from an external device. In some examples, RH information of an environment can include weight change information of a print media. For example, if the weight of the print media changes from a first time period to second it can be determined that the moisture content of the print media has changed which can be due to the change in RH of the environment. In some examples, RH information can be received based on a weight of print media (e.g., weight per sheet). In some examples, a top portion of a stack of print media may weigh more than a middle portion of the stack due to direct exposure to the environment causing it to retain more moisture.

Instructions 210, when executed by processor 206 can determine the moisture content based on an amount of time a print media is in an environment. For example, if a first print media is exposed to the environment for a longer period of time than a second print media, the first print media can be determined to have a moisture content higher than the second print media.

Instructions 216, when executed by a processor such as the processor 206, can include instructions to determine a colormap from a plurality of colormaps corresponding to the determined moisture content. In some examples, the plurality of colormaps can be determined for different temperatures of a thermal printhead of a thermal printing device, as described herein. In some examples, a colormap can be determined based on an average of two or more associated parameters of neighbor colormaps. In some examples, the parameters can be temperature and/or RH of the environment. For example, if a printhead temperature is 35-degrees C., then an average is taken from colormaps at 30-degrees C. and 40-degrees C. and used to determine the colormap at 35-degrees C. Similarly, if the moisture content of the print media is 3%, then an average is taken from colormaps at a 2% moisture content and a 4% moisture content and used to determine the colormap appropriate for a 3% moisture content of the print media.

In some examples, the determination of the colormap can change in response to a change in RH. For example, the non-transitory MRM can include instructions executable to determine a first colormap based on the received information that the RH of the environment of the thermal printing device is 20%. If the RH of the environment of the thermal printing device changes from 60% to 80%, processor 206 can include instructions to determine a second colormap in response to the change in RH. Similarly, if temperature and the humidity in the environment changes, instructions 216, executed by a processor such as the processor 206, can include instructions to determine a third colormap in response to the changes. As described herein, changes in the RH, temperature and/or humidity can be received from an external device. For example, a mobile device can receive information about the change on RH while a printing job is in progress. Based on that received information a new colormap can be determined for the changed RH, and a new thermal energy can be determined to correspond to the newly determined colormap for accurate representation of colorants. In some examples additional moisture content information, colormap information, and particular thermal energy information can be received from an external device. In some examples, a user can adjust and/or change colormap to optimize the colorants printed on a print media.

In some examples, a user can select the time to determine the colormaps. For example, the user can select preferred colorants for a print job during a first time period. Based on the selected preferences and RH of the environment a colormap can be determined for the print job during a first time period. In some examples, the user can select a different colormap other than the determined colormap to optimize the colorants printed on the thermal print media based on the user's preference.

Instructions 218, when executed by a processor such as the processor 206, can include instructions to determine a particular thermal energy to apply to the print media based on the determined colormap of the plurality of colormaps. For example, a first thermal energy to apply to the print media can be determined based on the determined first colormap and a second thermal energy to apply to the print media can be determined based on the determined second colormap.

In some examples, the particular thermal energy can be applied via a heating device within the thermal printing device. In some examples, the heating device can generate heat to activate thermo-sensitive coloring layer of a thermal print media, which may change colorants in areas where heat is received. The particular thermal energy, determined based on determined colormap, can correct colorants shifts caused by moisture content of the thermal print media and RH of the environment of the thermal printing device,

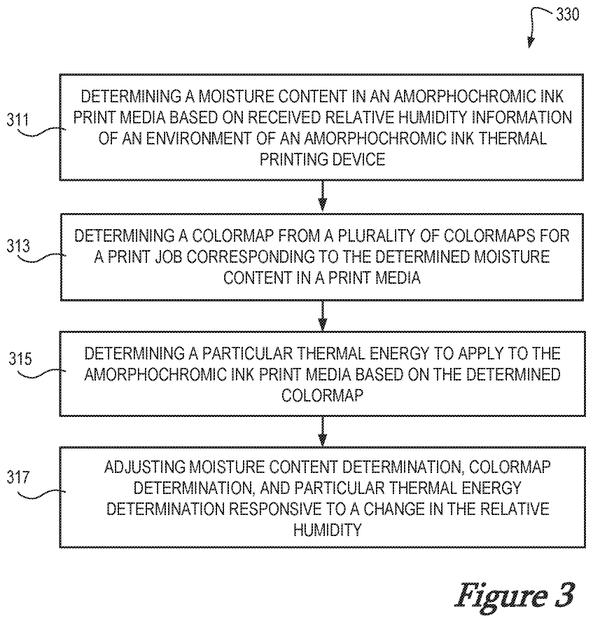

FIG. 3 is an example method 330 for thermal energy determination consistent with the disclosure. In some examples, the method 330 can be performed by system 100 or 220. At 311, the method 330 includes determining moisture content in an amorphochromic ink print media based on received RH information of an environment of an amorphochromic ink thermal printing device. In some examples, receiving information of the environment includes at least one of receiving an internal temperature read of the environment, receiving an external temperature read of the environment, receiving humidity information of a print media, receiving weight change information of a print media in response to the determined moisture content.

At 313, method 330 includes determining a colormap from a plurality of colormaps for a print job corresponding to the determined moisture content of the amorphochromic ink print media. In some examples, the plurality of colormaps can be determined for different temperatures of a thermal printhead of the amorphochromic ink thermal printing device. In some examples, the plurality of colormaps can be humidity adjusted colormaps. In some examples, a plurality of colormaps are determined for different RH of the environment of a thermal printing device, as described herein.

At 315, method 330 includes determining a particular thermal energy to apply to the amorphochromic ink print media based on the determined colormap. In some examples, thermal energy can be heat energy that optimizes the colorants printed on the thermal print media. In some examples, the applied particular thermal energy can be an applied heat that adjusts amorphochromic inks coated into the print media in accordance with the colormap.

At 317, method 330 includes adjusting the moisture content determination responsive to a change in the RH. Moisture content can be based on the RH of the environment. and an amount of time the print media is in the environment. For example, if the RH of the environment is 70% moisture content of a print media can be 5%, and if the RH of the environment is 90%, the moisture content of the print media can be 6%. If moisture content of the print media changes from 5% RH to 6% method 330, at 317, can adjust the colormap by determining the particular thermal energy and correct colorants shifts caused by the moisture content of the print media.

Method 330, in some examples, includes adjusting the colormap determination responsive to a change in the RH. For example, if RH of the environment changes from 20% RH to 40% RH, method 330, at 317, can adjust the colormap by determining the particular thermal energy and correct colorants shifts caused by the RH change in the environment. In some examples, the colormap can be adjusted by a computing device. In some examples, the colormap can be adjusted by a user based on the user's preference.

Method 330, in some instances, includes adjusting the particular thermal energy determination responsive to a change in the RH. For example, if RH of the environment changes from 20% RH to 40% RH, method 330, at 317, can adjust the particular thermal energy and correct colorants shifts. In some examples, by adjusting thermal energy, the amount of amorphochromic ink that is that is melted and/or developed is adjusted in accordance with the determined colormap.

The figures herein follow a numbering convention in which the first digit corresponds to the drawing figure number and the remaining digits identify an element or component in the drawing. For example, reference numeral 106 can refer to element 106 in FIG. 1 and an analogous element can be identified by reference numeral 206 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements can be present. In contrast, when an object is “directly coupled to” or “directly coupled with” another element it is understood that are no intervening elements (adhesives, screws, other elements), etc.

The above specification, examples and data provide a description of the method and applications and use of the system and method of the disclosure. Since many examples can be made without departing from the spirit and scope of the system and method of the disclosure, this specification merely sets forth some of the many possible example configurations and implementations.

What is claimed is:

1. A system, comprising:
a first controller comprising a processor; and
a non-transitory machine-readable medium (MRM) communicatively coupled to the processor, the non-transitory MRM containing instructions executable by the processor to cause the processor to:
receive relative humidity information of an environment of a thermal printing device;
determine a colormap to a print media of the thermal printing device based on the relative humidity; and
determine a particular thermal energy to apply to the print media based on the determined colormap.

2. The system of claim 1, further comprising instructions executable to determine the colormap based on a moisture content of the print media, wherein the moisture content is based on the relative humidity and an amount of time the print media is in the environment.

3. The system of claim 1, further comprising the instructions executable to receive the relative humidity information from an external device.

4. The system of claim 1, further comprising the instructions executable to receive the relative humidity information from a sensor embedded in the thermal printing device.

5. The system of claim 1, further comprising the instructions executable to determine the colormap by interpolation of two neighbor colormaps.

6. The system of claim 1, wherein the applied particular thermal energy is an applied heat that adjusts amorphochromic inks coated into the print media in accordance with the colormap.

7. The system of claim 1, further comprising instructions executable to:
change the colormap responsive to changing relative humidity; and
redetermine the determined thermal energy responsive to a changing colormap.

8. A non-transitory machine-readable medium (MRM) including instructions executable by a processor to:
determine moisture content in a print media based on:
a received relative humidity information of an environment of a thermal printing device; and
an amount of time the print media is in the environment;
determine a colormap from a plurality of colormaps corresponding to the determined moisture content; and
determine a particular thermal energy to apply to the print media based on the determined colormap.

9. The non-transitory MRM of claim 8, comprising instructions executable to instruct a heating device within the thermal printing device to apply the particular thermal energy to the thermal printing device.

10. The non-transitory MRM of claim 8, comprising instructions executable to receive additional moisture content information, colormap information, and particular thermal energy information from an external device.

11. The non-transitory MRM of claim 8, comprising instructions executable to adjust the colormap responsive to change in relative humidity in the environment during a print job.

12. The non-transitory MRM of claim 8, comprising instructions executable to adjust the colormap responsive to change in relative humidity in the environment prior to starting a print job.

13. A method comprising:
determining moisture content in an amorphochromic ink print media based on received relative humidity information of an environment of an amorphochromic ink thermal printing device;
determining a colormap from a plurality of colormaps for a print job corresponding to the determined moisture content;
determining a particular thermal energy to apply to the amorphochromic ink print media based on the determined colormap; and
adjusting the moisture content determination, the colormap determination, and the particular thermal energy determination responsive to a change in the relative humidity.

14. The method of claim 13, wherein determining the moisture content includes receiving additional information of the environment via a sensor.

15. The method of claim 14, wherein receiving the additional information includes receiving an internal temperature read of the environment; receiving an external temperature read of the environment, receiving weight change information of a print media, or receiving colorant variation information in response to the determined moisture content.
